(19) United States
(12) Patent Application Publication
(10) Pub. No.: US 2019/0022888 A1
(43) Pub. Date: Jan. 24, 2019

(54) EQUIPMENT AND METHOD OF TRANSVERSAL CUTTING FOR TRIMMING STRIPS

(71) Applicant: Tecnau S.r.l., Ivrea (TO) (IT)

(72) Inventors: Pier Paolo Villois, Ivrea (IT); Armando Aprato, Ivrea (IT); Giuliano De Marco, Ivrea (IT)

(21) Appl. No.: 16/038,974

(22) Filed: Jul. 18, 2018

(30) Foreign Application Priority Data
Jul. 18, 2017 (IT) 102017000081301

(51) Int. Cl. B26D 7/18; B41F 13/58; B26D 7/01

(52) U.S. Cl. CPC B26D 7/1863; B26D 7/018; B41F 13/58

(57) ABSTRACT

A cutting equipment trims strips of webs in movement by means of a stationary trimming blade and a rotating cylinder with a mobile trimming blade during transversal cuts and separation of basic sheets. The rotating cylinder includes a sector with suction openings connected to a vacuum source, which retains the strips by suction and drags the strips up to a collector of the trimmed strips. The cutting equipment cuts and separates transversal strips of two webs overlapped in adherence jointly to the cutting of the basic sheets. To this end, a perforating device perforates a row of holes on the first web adjacent to an edge of the sheets: a first web is positioned with the row of holes in front of the suction openings, while the strip of the second web is retained and dragged by suction through the holes of the first web up to the collector of the trimmed strips.

### RELATED APPLICATION

This application claims priority to Italian Application No. 102017000081301 filed on Jul. 18, 2017 and entitled “Equipment and method of transversal cutting for trimming strips”, the content of which is incorporated herein by reference in its entirety.

### FIELD OF THE INVENTION

The present invention relates to an equipment and a method of transversal cutting for trimming strips of moving webs.

More specifically the invention relates to a transversal cutting equipment for trimming strips of webs moving along a given direction, comprising: a stationary fixed trimming blade, a trimming blade carrying cylinder, rotatably mounted around a rotating axis, of support for a movable trimming blade, a vacuum source, and a collector for the trimmed strips.

According to a typical technology, the web arriving from printers is cut by suitable cutting apparatuses for subsequent processing on line, or is wound in rolls from which the web is then unwound of-fine and cut in movement. This, with a speed of the web more than 400 m/min for a high operative productivity.

### BACKGROUND OF THE INVENTION

With the cutting of the web, various sheets with single or multiple images are thereby separated for following processing. However, the thus cut sheets generally have defects dependent on the printer or on the printing processes and/or cutting. These defects, aesthetically unacceptable, may be constituted by torn out parts, parts with prints or service codes of the printer and, in the case of ink jet printers, bleed areas for the bleeding of the heads. The cutting of separation of the sheets from the web does not eliminate the defects, making it necessary a trimming cut for removing a small strip of web constituted by the torn out or bleed area or of a width sufficient to cover the area to be removed.

In this framework, the equipments of transverse cutting and removal for trimming strips of webs have an important role. According to a typical structure, these equipments comprise a fixed trimming blade, a blade carrying cylinder mounted for rotation about an axis of rotation of support for a movable blade, a source of vacuum and a collector for the trimmed strips. With the rotation of the blade carrying cylinder, the movable blade cooperates with the fixed blade for separating the strips, while a retaining sector of the cylinder adjacent to the blade retains the strips by suction, by means of suction openings connected to the vacuum source and drags the strips from the area of the cut up to the collector for the trimmed strips.

The structure for retaining the trimming strips by suction is associated with complex and costly devices if the strips should be cut and removed from continuous paper forms in a overlapping. Such webs are derived from webs of width double with respect to the width of the sheet to be produced and are cut longitudinally and overlapped in suitable apparatuses [merger], for optimizing printing costs and productivity.

### SUMMARY OF THE INVENTION

General object of the present invention is to provide a cutting equipment and method for trimming strips of moving webs which can process overlapped continuous paper forms, ensuring a high productivity and which results reliable and of relatively low cost.

This object is achieved by the equipment of cutting for trimming strips for overlapped webs of the above specified type, with the use of a holing mechanism for transversal perforations and in which a first web is arranged in use in front of a trimming blade carrying cylinder. The holing mechanism is operable for executing a row of transversal holes on the first web adjacent to a respective edge of separation and wherein the row of holes can be positioned in front of the suction openings in association with the cuts for a suction action also on the second web, and the suction action is such as to retain overlapped and in adherence on the retaining sector the strips of the first web and the strips of the second web in adherence on the strip of the first web during the cutting and the dragging of the strips up to the strip collector.

The method for trimming strips of the invention uses an equipment comprising: a fixed trimming blade, a trimming blade-carrying cylinder rotating around a rotating axis, of support for a movable trimming blade, a vacuum source, and a strip collector. The equipment is associated with a separating transversal cutting device for executing transversal separation edges on the webs and the movable trimming blade is provided for cooperating with the fixed trimming blade for separating adjacent strips adjacent to the transversal separation edges. The trimming blade-carrying cylinder includes a retaining sector, adjacent to the movable trimming blade, having a plurality of suction openings connected to the vacuum source for retaining the strips by suction, and dragging said strips up to the strip collector, and wherein the equipment further comprises a holing mechanism for effecting holes transversely on one of the webs. Said method applies to the cutting and separation of trimming strips of two webs overlapped in adherence and comprises the following steps:

a) holing a first web disposed in front of the trimming blade carrier cylinder, with a row of holes adjacent to a respective edge of the separation edges;
b) positioning the row of holes in front of the openings in association with the cuts for a suction action also on the second web; and
c) executing a suction action such to retain overlapped and in adherence, on the retaining sector, the strips of the first web and the strips of the second web during cutting and dragging up to the strip collector.

### BRIEF DESCRIPTION OF THE DRAWINGS

The characteristics of the invention will become clear from the following description, given purely by way of non-limiting example, with reference to the appended drawings in which:

FIG. 1 represents a schematic side view of a transversal cutting equipment for trimming strips of moving webs, in accordance with a first embodiment of the invention;

FIG. 2 shows schematically a section at a very large scale of some details of the equipment of FIG. 1;

FIG. 3 is a section at an enlarged scale of details of FIG. 1;

FIG. 4 shows a schematic plan view of the cutting equipment of FIG. 1;

FIG. 5 is a schematic front section at an enlarged scale of a component of the cutting equipment of FIG. 1;

FIGS. 5A and 5b show, at an enlarged view, a section and a view of some details of the component of FIG. 5;

FIG. 6 represents a schematic section of some components of the cutting equipment for trimming strips of FIG. 1;

FIG. 7 shows a schematic view of the cutting equipment in accordance with a first example of embodiment of the invention;

FIG. 8 shows a schematic view of a part of the strip treated by the cutting equipment for trimming strips of FIG. 1;

FIG. 9 shows a schematic view of some details of the web of FIG. 8;

FIG. 9a is a schematic view at an enlarged scale of a section of the web of FIG. 8;

FIGS. 9B and 9c are schematic views, at enlarged scale, of variants of the section of the web of FIG. 9a;

FIG. 10 is a schematic view of a component of the equipment of FIG. 1;

FIG. 10a is a diagrammatic section at an enlarged scale of the component of FIG. 10;

FIG. 10b shows a diagrammatic section, at an enlarged scale, of the component of

FIG. 10, in accordance with a variant of the invention;

FIG. 11 is a schematic view of another component of the equipment of FIG. 1;

FIG. 12 is a schematic section of a component of the transversal cutting equipment, in accordance with a variant of the invention;

FIG. 13 is a schematic view of a component of transversal cutting equipment, in accordance with the variant of the invention of FIG. 12;

FIG. 14 is a schematic view of a part of the web treated by the cutting equipment, in accordance with the variant of FIG. 12;

FIG. 14a shows a schematic view, at an enlarged scale, of a section of the web of FIG. 14;

FIG. 15 represents a flow chart of the method of cutting for trimming strips in accordance with the invention;

FIG. 16 is a schematic side view of a transversal cutting equipment for trimming strips, in accordance with a second example of embodiment of the invention;

FIG. 17 is a sectional view, at an enlarged scale, of some details of the transversal equipment of FIG. 16;

FIG. 18 is a schematic view of a part of the web treated by the transversal cutting equipment of FIG. 16;

FIG. 19 shows a schematic section of some components of the cutting equipment for trimming strips of FIG. 16;

FIG. 20 shows a schematic view of the cutting equipment according to a second example of embodiment of the invention; and

FIG. 21 is a schematic view of a component of the equipment of FIG. 20.

### DETAILED DESCRIPTION OF THE PREFERRED EMBODIMENTS

### First Example of Embodiment of the Invention

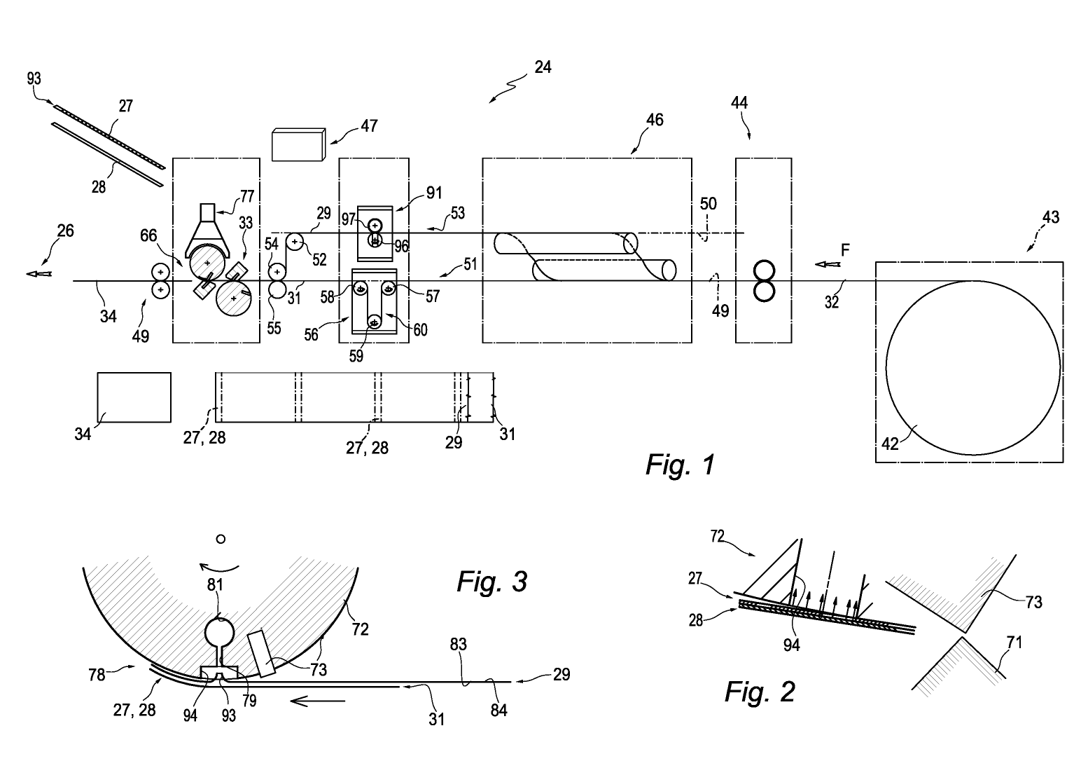

FIG. 1 shows a transversal cutting equipment 24 for trimming strips of webs or continuous paper forms in movement, in accordance with a first embodiment of the invention. The equipment 24 feeds with trimmed sheets a system for the automatic processing of documents, generally designated by reference numeral 26.

The transversal cutting equipment 24 is used for cutting and separating trimming strips 27 and 28 of two webs 29 and 31. The webs 29 and 31 are overlapped in adherence and are derived by longitudinally cutting and merging from an original web 32 in movement, according to a two-up technique. As described below, the sheets are separated by a transversal cutting apparatus 33 and the equipment 24 operates in combination with the cutting apparatus 33 for trimming the overlapped sheets as trimmed sheets for the system 26.

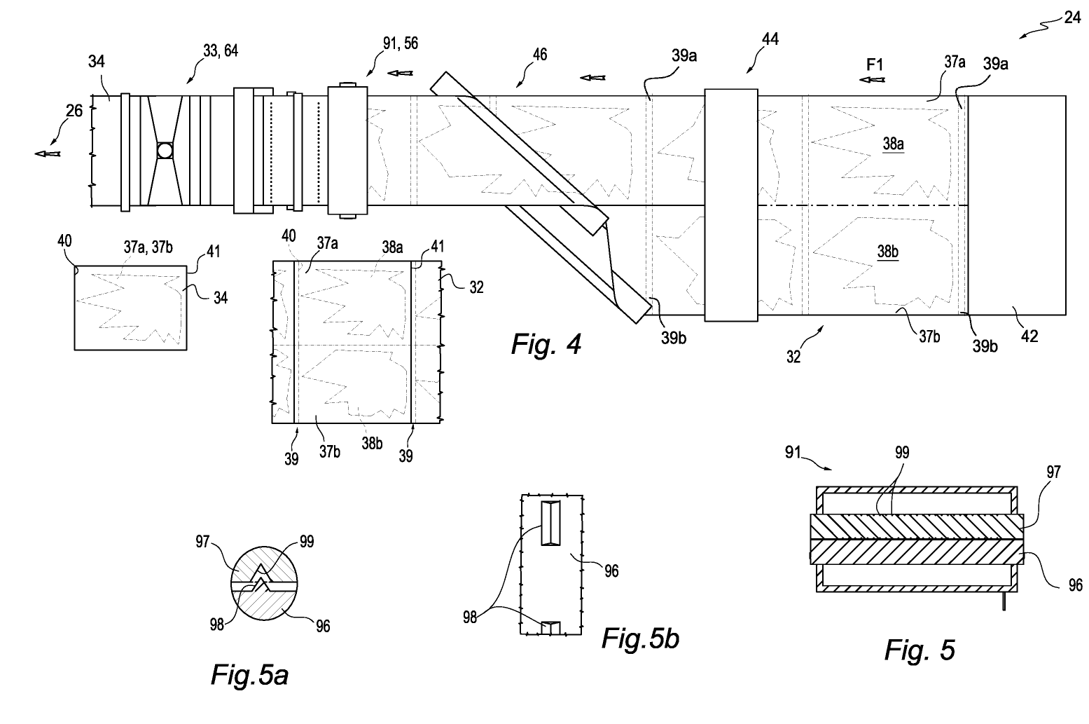

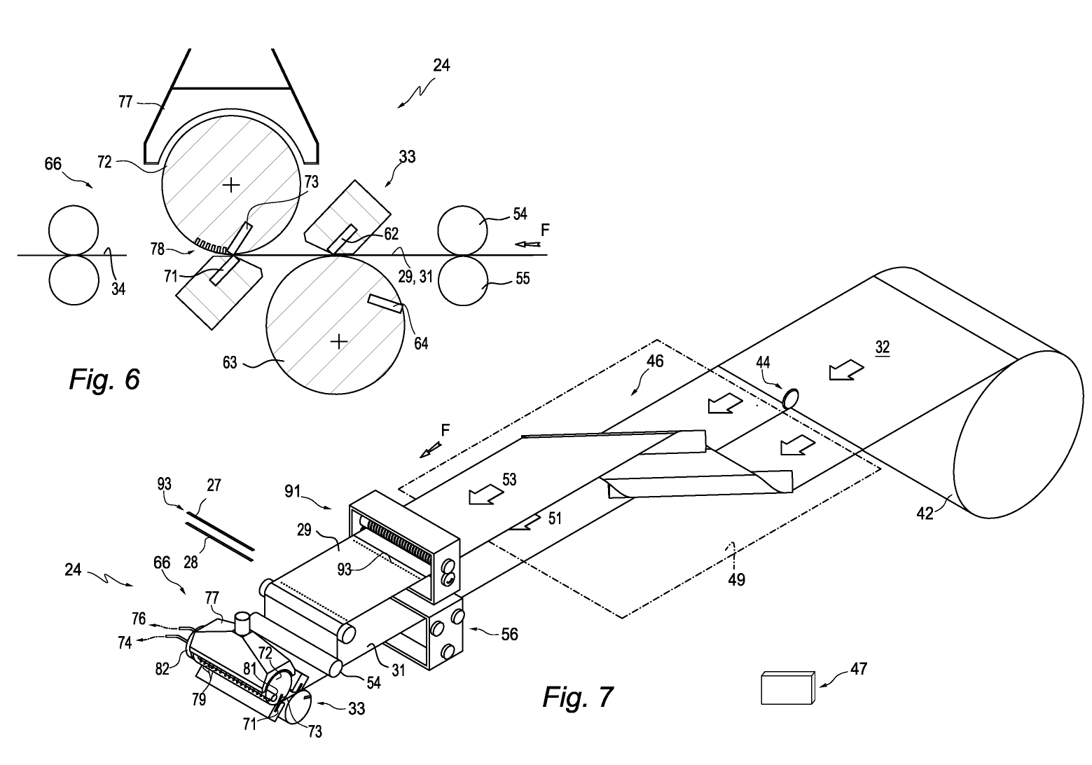

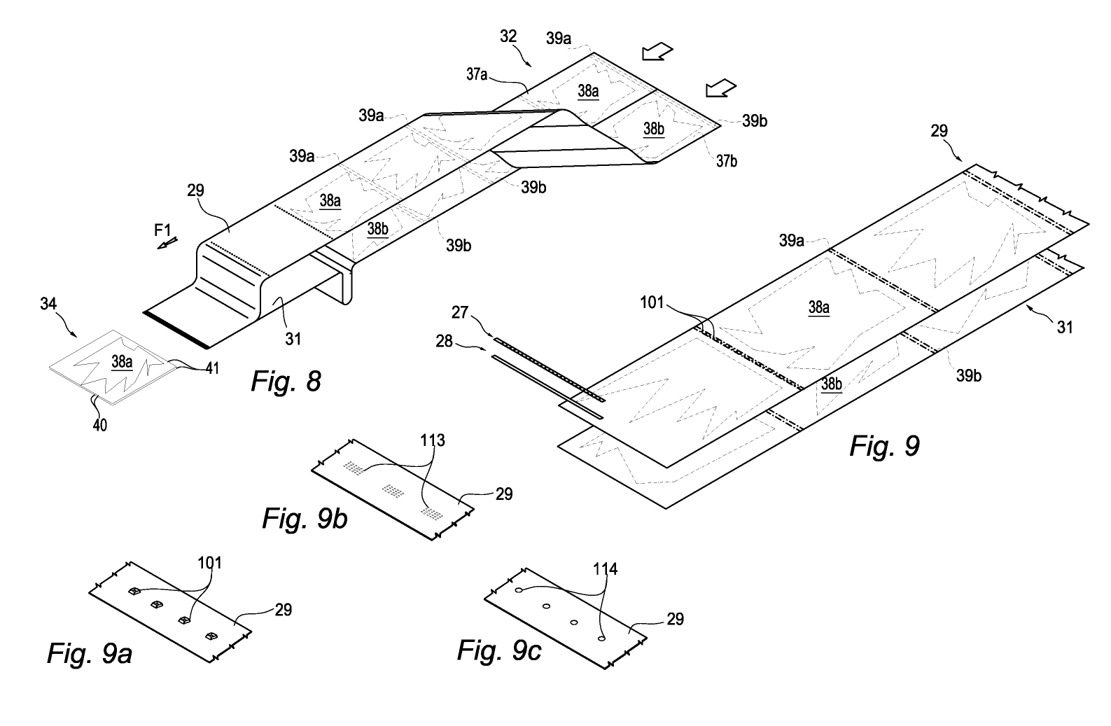

The original web 32 (FIGS. 4 and 8) defines basic sheets 37a and 37b with respective images 38a and 38b, printed digitally, and arranged in sequence along two rows side by side and intended to generate the trimmed sheets 34. Between the images in sequence 38a and 38b there are separating areas 39a and 39b with defects aesthetically unacceptable for the sheets intended to the system for the automatic processing of documents 26. The equipment 24 removes these areas with the trimming strips 27 and 28 from initial portions of the basic sheets 37a and 37b so as to form clean leading edges 40 and trailing edges 41 of the trimmed sheets 34. The defects can be constituted by torn out edges, marginal portions of the sheets with service prints or codes of the printer and, in the case of ink jet printers, areas of bleed for the bleeding of the heads.

In the following description, the transversal cutting equipment 24 operates off-line from a printer, not shown, that generated the images 38a and 38b and in which the web 32, after the printing, has been wound into a reel 42. The cutting equipment of the invention can, however, also operate on-line on the web 32, downstream of the printer for the images 38a and 38b.

The transversal cutting equipment 24 is associated to an unwinding device 43, to a longitudinal cutting and overlapping group including a longitudinal cutting device 44 and to a deviating device 46. The unwinding device 43 unwinds the web 32 from the reel 42 and whereas the cutting device 44 divides the web longitudinally side by side 32 forming the webs 29 and 31 on a geometrical plane 49.

The movements occur, at high speed and by means of not shown mechanisms, along a direction of movement “F” parallel to a longitudinal axis of the web 32. The deviating device 46 provides to divert the first web 29 upwards from the condition of side by side with the web 31 to a condition of alignment and offset in height with respect to the web 31 on a geometrical plane 50 higher with respect to the plane 49. The web 31 proceeds along a direct path 51 on the plane 49, while the web 29 proceeds with support on an upper roller 52 along a deviated path 53, on the higher plane 50 and in condition of parallelism with the path 51. Then, a lower support roller 54 deflects the web 29 from the upper support roller 52 downwards and to the geometrical plane 49 and on a condition of overlapping and adherence with respect to the web 31 along the plane 49 with the cooperation of a counter roller 55.

To the transversal cutting equipment 24 is also associated a compensating mechanism 56 (FIGS. 1 and 11) operating on the web 31. The mechanism 56 is provided for compensating the difference in length of the portions of the webs between the deviated path 53 of the web 29 and the direct path 51 of the web 31 for a correct alignment of the basic sheets 37a and 37b in front of the transversal cutting apparatus 33. The mechanism 56 is arranged upstream of the lower roller 54 and the counter-roller 55 and comprises two upper support rollers 57 and 58 and a lower support roller 59. The upper rollers 57 and 58 support the web 31 on the plane 49, while the lower roller 59 is arranged in an intermediate position below the rollers 57 and 58 and defines a loop 60 for the web 31.

The transversal cutting apparatus 33 is arranged downstream of the lower roller 54 and the counter roller 55 and is operable for cutting together the webs 29 and 31 and separating the aligned basic sheets 37a and 37b with definition of the trailing edges 41 of the trimmed sheets 34.

The cutting apparatus 33 comprises a fixed edge blade 62, substantially stationary, and an edge blade carrying cylinder 63 with a movable edge blade 64 arranged below and, respectively, above the plane 49. The edge blade 62 and the edge blade carrying cylinder 63 are arranged transversely to the direction of movement “F”, while the overlapped webs 29 and 31 follow a cutting path in a space between the blade 62 and the cylinder 63.

The rotation of the edge blade carrying cylinder 63 is synchronized with the movement of the webs 29 and 31 under the control of the electronic unit 47 in such a way as to carry out the cutting of the edges 41 of the basic sheets on the passage of the movable blade 64 against the fixed blade 62 in a manner known per se.

For separating the strips, the equipment 24 includes, downstream and close to the transversal cutting apparatus 33, a trimming apparatus 66 comprising a fixed trimming blade 71 and a trimming blade carrying cylinder 72 of support for a movable trimming blade 73. The blade carrying cylinder 72 is arranged above the geometrical plane 49, while, respectively, the fixed trimming blade 71 is arranged below the plane 49.

The trimming blade carrying cylinder 72 is mounted for rotation on an axis of rotation parallel to the axis of the cylinder 63 and is controlled by the electronic unit 47 for executing a trimming cut on the webs 29 and 31 on the passage of the movable trimming blade 73 in contrast with the fixed trimming blade 71.

The trimming apparatus 66 also comprises a vacuum source 74, a compressed air source 76 and a strip collector 77. The trimming blade carrying cylinder includes a retaining sector 78 adjacent to trimming blade 73 and has a series of suction openings 79 on the sector 78 and an axial duct 81 connected with the openings 79.

The trimming blade carrying cylinder 72 cooperates at one end with a rotating shutter 82 for connecting the duct 81 to the vacuum source 74 or with the compressed air source 76 as a function of the angular position of the trimming blade carrying cylinder 72. The strip collector 77 is disposed above the cylinder 72 and is also connected to a vacuum source for the collection of previously separated trimming strips.

According to the known art, the retaining sector 78 exerts a suction action and a retaining action on a position of the webs adjacent to the cut and an ejection action for a position in front of the strip collector 77. For a typical, non limitative use, the electronic unit 47 controls the rotation of the trimming blade carrying cylinder 72 so as to trim trimming strips of 4-25 mm of width.

In accordance with the invention, the webs 29 and 31 are kept in adherence, downstream of the transversal cutting apparatus 33 and along a cutting path passing between the fixed trimming blade 71 and the trimming blade carrying cylinder 72 for a simultaneous cutting of the two webs. In use, the web 29 therefore has a lower face 83 adhering to the web 31 and an opposite face 84 facing the trimming blade carrying cylinder 72, while the web 31 has an upper face adherent to the web 29 and an opposite surface facing the fixed trimming blade 71.

Cutting and separation of the trimming strips 27 and 28 of the webs 29 and 31 are carried out in a condition of overlapping and adherence by suction on the retaining sector 78 through holes on the web 29 facing the cylinder 72.

To this end, the transversal cutting equipment 24 comprises a holing mechanism including, for example, a perforating device 91 which can be activated by the electronic control unit 47 for executing a row of holes constituted by transversal perforations 93 on the first web 29, upstream and adjacent to a trailing edge 41 of separation for the trimmed sheets 34.

In association with the trimming cut, the strip 27 with the row of perforations 93 can be positioned in front of the suction openings 79 of the retaining sector 78 for a suction action which is exerted also on the second web 31. The suction action is such as to retain in overlapping and adherence on the sector 78 the strips 27 of the web 29 and the strips 28 of the web 31 in overlapping and adherence on the strips 27 during the cutting and the dragging of the strips up to the strip collector 77. In known manner the strips are ejected from the retaining sector 78 by means of a jet of compressed air through the suction openings 79, collected by suction by the collector 77 and transported in a not shown container.

For a more efficient suction action, the trimming blade carrying cylinder 72 (FIG. 3) defines, along a generatrix, a longitudinal groove 94 in the retaining sector 78. The suction openings 79 are arranged along the groove 94, which is substantially aligned with the row of perforations 93 during the cutting of the strips 27 and 28.

Conveniently, the perforating device 91 operates with perforating elements acting on a face 83 of adherence of the web 29 with the retaining sector 78. In this way, bends and buns normally caused by the perforation face in use toward the groove 94 of the retaining sector for a plain contact and sealing of the strip on the retaining sector 78. According to a non limiting example, the groove 94 has a width of 2-4 mm, typically 3 mm, and a depth of 0.1-0.8 mm.

The perforating device 91 (FIG. 1) is arranged along the deviated path 53 of the web 29, partially in the space between the planes 49 and 50 and comprises, in vertical alignment, a lower tooth carrying support 96 (FIGS. 5, 7 and 10) and an upper contrast roller 97. The tooth carrying support 96 and the roller 97 are rotatably mounted on respective rotation axes parallel to each other and transversal to the direction of movement “F” of the web 29 and define a space for the passage of the web 29. The tooth carrying support 96 is of parallelepiped shape of limited thickness and includes on each edge a row of perforating teeth 98 parallel to the axis of rotation, while the contrast roller 97 defines annular grooves 99 associated to the row of teeth 98.

By way of a non limitative example, the perforation teeth 98 are made from a blade of 1.0-2.5 mm of thickness with a pitch of about 3-5 mm and a width of the teeth at the base of 2.0-3.5 mm, for perforations 93 of quadrangular shape of 0.8 to 1.5 mm and pitch of 3-5 mm.

The tooth carrying support 96 is rotated by a servomechanism controlled by the electronic unit 47 for executing, on the fly, the transversal perforations of the first web 29 at predetermined distances along the direction “F” from the edge of separation of the sheets. The perforation teeth 98 can also be of elongated shape, parallel to the axis of rotation of the support 96 for obtaining perforations 101 with a greater section of suction, in use, toward the web 31.

In the case of webs 29 and 31 with extended separation areas 102a and 102b (FIG. 14), the equipment 24 comprises a perforating device 103 (FIG. 13) with two tooth carrying support 104 and two contrast rollers 105. This for executing two flanked rows of transversal perforations 106a and 106b (FIGS. 14 and 14a) for the areas 102a and 102b and corresponding trimming strips 107 and 108, so as to obtain an appropriate action of suction on the second web 31. In alternative, the two rows of perforations 106a and 106b can be obtained by a double actuation of the perforating device 91.

As other alternative for the double perforation, the transversal cutting equipment 24 provides, in the perforating device 91, a tooth carrying support 110 (FIG. 10b) with a double row of teeth in lieu of the support 96, when this is deemed appropriate. In detail, the support 110 mounts on each edge two rows of perforation teeth 98a and 98b parallel to the axis of rotation of the support 110 and at a distance associated to the one of the rows of transversal perforations 106a and 106b. In use, the two rows of teeth perform on the web 29 the perforations 106a and 106b at their passage in front of the annular grooves 99.

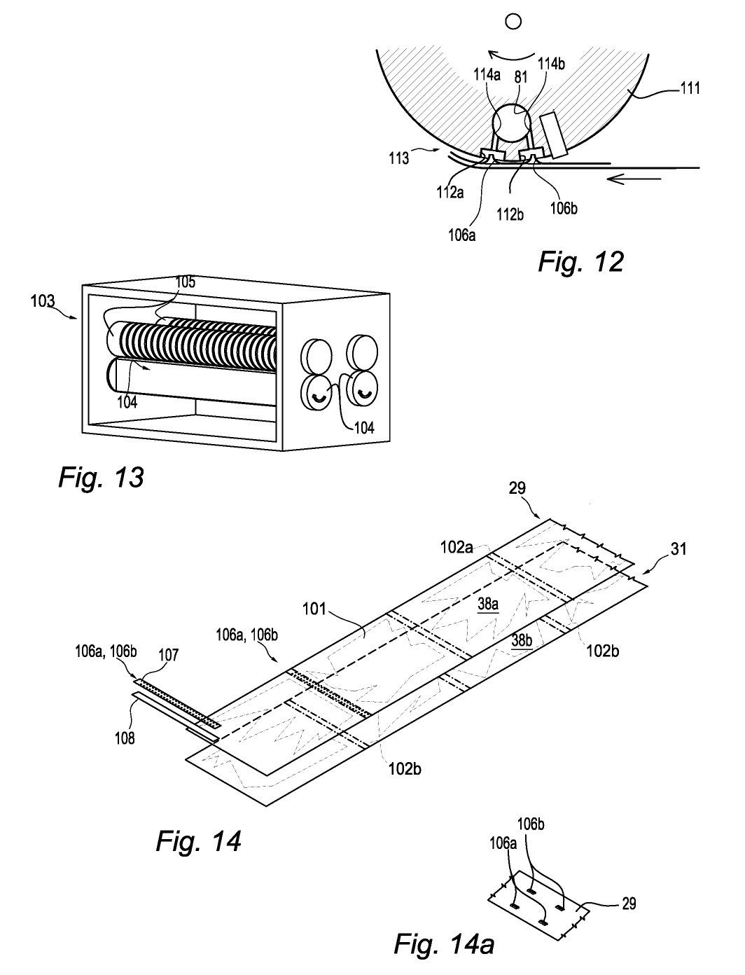

For processing the webs 29 and 31 with double perforation on the web 29 a trimming blade carrying cylinder, represented with 111 in FIG. 12, comprises two longitudinal grooves 112a and 112b in a retaining sector 113. In the grooves 112a and 112b insist corresponding suction openings 114a and 114b, connected to the axial duct 81 and which, in operating conditions, are substantially aligned with the rows 106a and 106b. Also the perforating device 103 operates with perforating elements acting on the face 83 of adherence of the web 29 for bends and burrs facing, in use, toward the grooves 112a and 112b. The trimming of the strips 107 and 108 (FIG. 14) is effected in a way similar to the one described for the trimming strips 27 and 28.

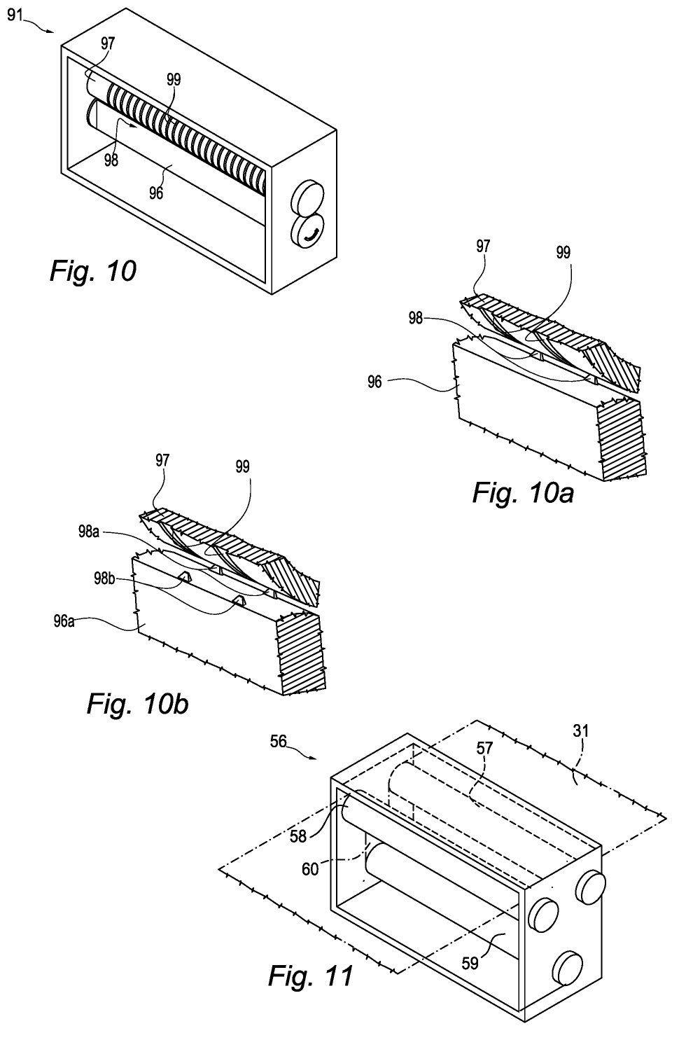

In alternative, the holing mechanism of the transversal cutting equipment 24 of the invention includes a device for micro-perforations, not shown in the drawings, similar to the perforating device 91 of FIG. 10, comprising a support for a series of needles or teeth for micro-perforations and a contrast roller for the needles or the teeth. The support for the needles or teeth is servo-controlled by the electronic unit 47, while the contrast roller has a peripheral speed synchronous with the feeding speed of the web 29. The needles or the teeth are distributed in rows and columns on the respective support for executing, on the fly, transversal micro-perforations 113 (FIG. 9b) with the same function of improved suction of the perforations 93.

The teeth for the micro-perforations can be formed of 4-5 juxtaposed blades of 0.3 mm of thickness, alternated with blades without teeth of the same thickness, in groups of 4 -6 teeth, and pitch of about 15 mm, for micro-perforations 113, purely indicative, of 0.2×0.6 mm, in areas of 2.5×6.0 mm and a pitch of 15 mm.

As another alternative, the holing mechanism of the cutting equipment 24 comprises a punching device, not shown, similar to the perforating device 91 with a punch holder support for a row of punches and a die support roller for respective dies. The punch holder support and the die support roller are servo-controlled by the electronic unit 47 for executing, on the fly, transversal punches 114 (FIG. 9c) on the web 29. An aspirating element, not shown, is associated to the punching device for collecting the scraps separated by the punching operation. The punches are cylindrical and have a cutting diameter of 1.5-3 mm, typically 2.5 mm with pitch of 10-20 mm, typically 15 mm for punches of the same diameter and the same pitch.

The alternative solutions with the micro-perforations or with the punches can be applied also to the webs 29 and 31 with extended separation areas, adopting solutions similar to those described for the perforations.

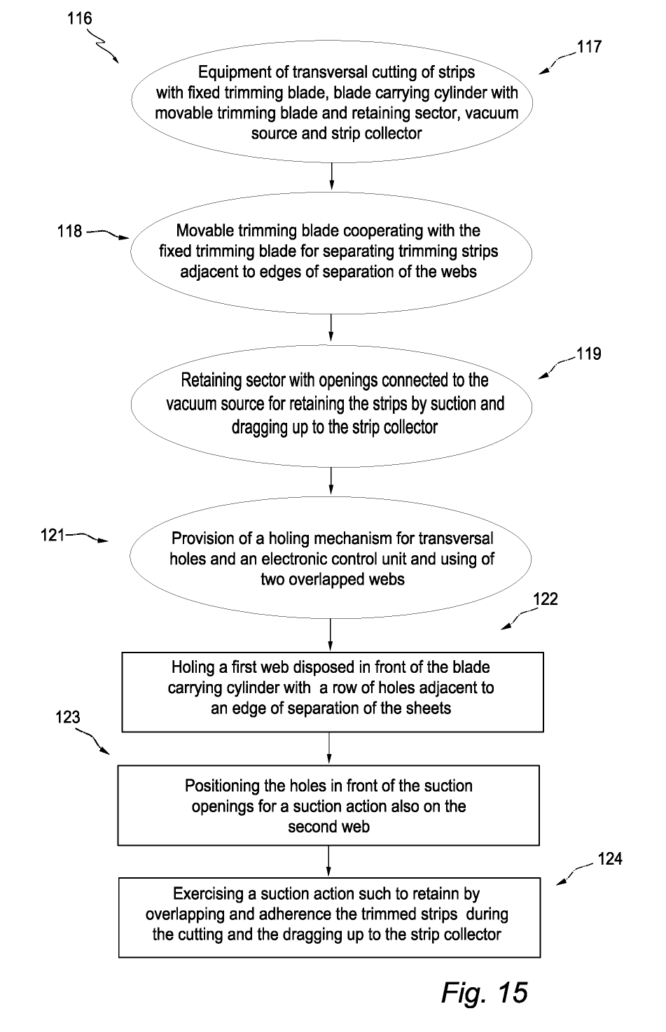

The method of cutting for trimming strips of the invention is represented by 116 in the flowchart of FIG. 15. The method 116 provides the use of a cutting equipment, condition 117 comprising a fixed trimming blade, a trimming blade carrying cylinder, rotating about an axis of rotation, of support for a movable trimming blade, a vacuum source, and a strip collector. The movable trimming blade cooperates with the fixed trimming blade for separating trimming strips adjacent to edges of separation of the webs, condition 118. The retaining sector has a series of suction openings connected to the vacuum source to retain the strips by suction and draw the strips up to the strip collector, condition 119.

The method 116 employs a holing mechanism for transversal holes and an electronic control unit, and it is used for cutting and separating trimming strips of two webs overlapped in adherence, condition 121 and comprises the following steps:

a) holing a first web disposed in front of the trimming blade carrier cylinder, with a row of holing adjacent to a respective edge of the separation edges, block 122;
b) positioning the row of holes in front of the openings in association with the cuts for a suction action also on the second web, block 123; and
c) exerting a suction action such to retain overlapped and in adherence, on the retaining sector, the strips of the first web and the strips of the second web during the cutting and the dragging up to the strip collector, block 124.

### Second Example of Embodiment of the Invention

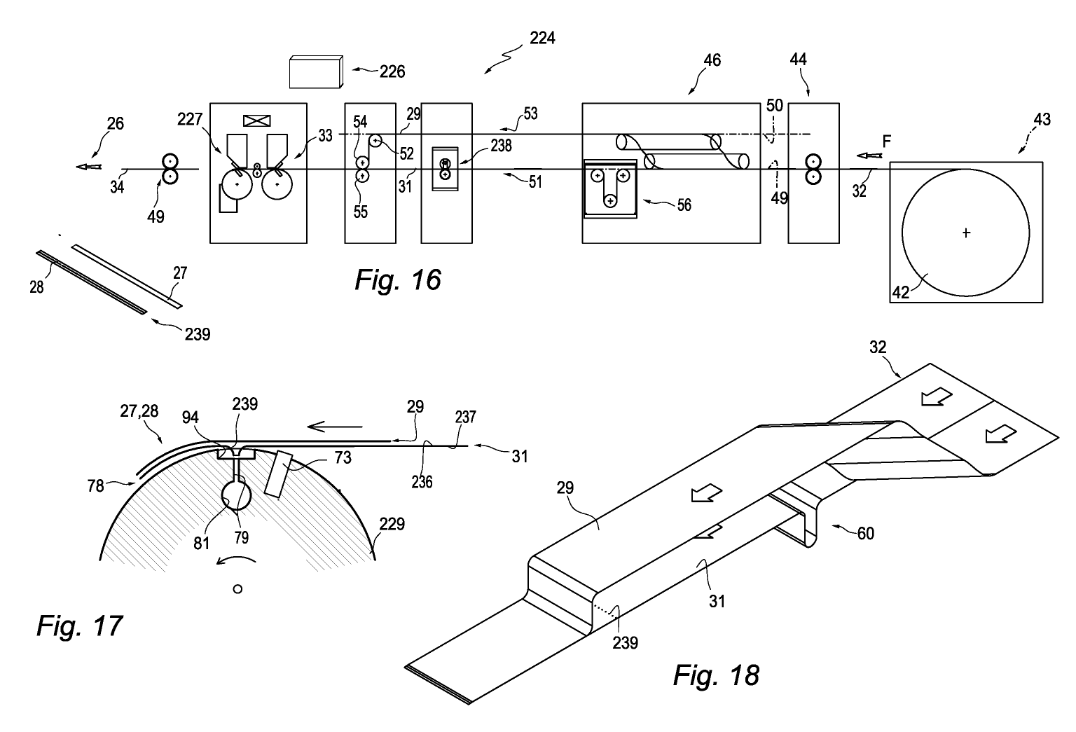

FIG. 16 represents a transversal cutting equipment 224 for trimming strips of webs or continuous paper forms in movement, in accordance with a second example of embodiment of the invention.

The equipment 224 is similar to transversal cutting equipment 24 of FIG. 1 and in which the components with the same function maintain the same numbering.

The cutting equipment 224 feeds the system for the automatic processing of documents 26 with the trimmed sheets 34 and is designated for cutting and separating the trimming strips 27 and 28 of the webs 29 and 31, respectively upper and lower, overlapped in adherence and obtained by longitudinal cutting and merging from a web 32 in movement.

The transversal cutting equipment 224 operates in association with the unwinding device 43 for the reel 42, with the longitudinal cutting device 44 and the deviating device 46 and is coordinated by an electronic control unit 226. Moreover, the equipment 224 operates in combination with the transversal cutting apparatus 33 for separating the basic overlapped sheets from the webs 29 and 31.

Also in this example of embodiment of the invention, the deviating device 46 (FIG. 20) deviates and moves in height the web 29 with respect to the web 31 with support on the upper roller 52 along the deviated path 53, while the lower web 31 proceeds along the direct path 51. The lower roller 54 causes the web 29 to contact in overlapping the web 31 and the compensation mechanism 56 for the tape 31 compensates for the differences in paths 51 and 53 as described for the transversal cutting equipment 24.

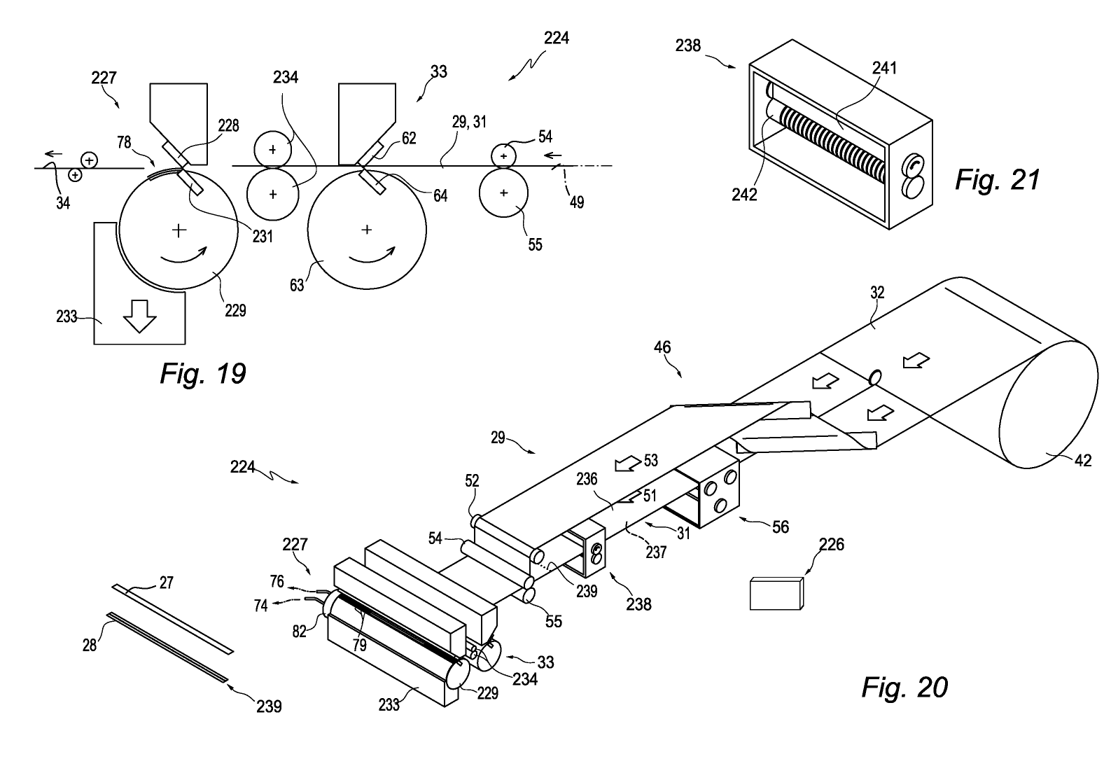

The cutting apparatus 33 (FIG. 19) comprises the fixed edge blade 62 and the edge blade carrying cylinder 63 with the movable edge blade 64 and in which the overlapped webs 29 and 31 follow a cutting path passing between the blade 62 and the cylinder 63. The rotation of the blade carrying cylinder 63 is in synchronism with the movements of the webs 29 and 31 and causes the cutting of the edges 41 of the basic sheets 37a and 37b (see FIG. 4) under the control of the electronic unit 226.

For the separation of the strips (FIGS. 19 and 20), the transversal cutting equipment 224 includes, downstream of the cutting apparatus 33, a trimming apparatus 227, similar to the trimming apparatus 66, comprising a fixed trimming blade 228 and a trimming blade carrying cylinder 229, mounted for rotation about an axis of rotation of support for a movable trimming blade 231. Unlike the arrangement of cylinder and trimming blade of the apparatus 66, the blade carrying cylinder 229 and the fixed trimming blade 228 of the trimming apparatus 227 are arranged below and, respectively, above the geometrical plane 49.

The trimming apparatus 227 (FIG. 20) also comprises the vacuum source 74, the compressed air source 76 and a strip collector 233. The trimming blade carrying cylinder 229 includes the retaining sector 78 and the axial duct 81. The retaining sector 78 is adjacent to the movable trimming blade 73 and has the series of suction openings 79 and the axial duct 81 and is connected, by means of the rotating shutter 82, to the vacuum source 74 or to the compressed air source 76 as a function of the angular position of the cylinder 72.

The strip collector 233 is arranged below the trimming blade carrying cylinder 229 and is connected to a vacuum source to collect the ejected trimming strips. The retaining sector 78 exercises the action of suction and retaining for a corresponding position adjacent to the position of cutting of the strip and the action of ejection for a position of the sector 78 in front of the strip collector 233.

Between the transversal cutting apparatus 33 and the trimming apparatus 227, the transversal cutting equipment 224 comprises two series of pairs of motorized pressure rollers 234. The rollers 234 maintain in adherence and draw the sheets separated after the cutting of the webs 29 and 31 by means of the blades 62 and 64 and in the passage between the fixed trimming blade 227 and the trimming blade carrying cylinder 229.

In this example of embodiment of FIG. 20, the lower web 31 has an upper face 236 adhering to the face 83 of the web 29 and an opposite face 237 facing the trimming blade carrying cylinder 229.

The transversal cutting equipment 224 is provided with a holing mechanism comprising a perforating device, here indicated by 238, having function similar to that of the perforating device 91. The perforating device 238 can be activated by the electronic control unit 226 to perform a row of transversal perforations 239 on the lower web 31 adjacent to the edge of separation of the sheets.

In association with the trimming cutting, the strip 28 of the lower web 31 with the row of perforations 238 (FIG. 17) can be positioned in front of the longitudinal groove 94 of the cylinder 229 and the suction openings 79 of the retaining sector 78. The suction action on the strip of the lower web 31 is exerted also on the trimming strips 27 of the upper web 29 whereby keeping it adherent to the strip 31. The suction action on the strips 27 and 28 continues during the cutting and their dragging up to the collecting strip collector 233 and ceases with the ejection of the strips and the suction thereof by part of the collector 233.

The perforating device 238 (FIGS. 20 and 21) is arranged along the direct path 51 of the web 31 and the perforating elements act on the face 236 for bends and burrs of the perforations 238 facing, in use, toward the groove 94 of the sector 78. In detail, the perforating device 238 includes, in vertical alignment, an upper tooth carrying support 241 and a lower contrast roller 242 with annular grooves, having functions similar to those of the tooth carrying support 96 and the contrast-roller 97 of the perforating device 91.

The transversal cutting equipment 224 can also provide the double perforations on the web 31 with devices similar to those of the equipment 24.

The strip cutting equipment of the invention, its components and the associated apparatuses may take other forms and variations. For example, in structures not shown, the perforation can be carried out downstream of the longitudinal cutting device 44, in the condition of longitudinal flanking of the webs 29 and 31.

As other variant, two deviating devices can be provided for obtaining the overlapped and offset in height condition of the webs 29 and 31 without any compensation mechanism. The webs 29 and 31 would be formed on a geometrical plane intermediate in height between the planes 49. A first deviating device provides to divert the web 29 upwards and to the left from the condition of flanking with the web 31 on the geometrical plane 50, whilst the second deviating device provides to divert the web 31 downwards and to the right from the condition of flanking with the web 29 on the geometrical plane 49, without any difference in the length of the deviated portion of the web. Also in this case the perforating device 91 would be partially arranged in the space between the planes 49 and 50. The other condition for the merging in overlapping of the webs 29 and 31 would be similar to the ones provided for the use of the deviating device 46 and the compensating mechanism 56.

Naturally, the principle of the invention remaining the same, the embodiments and the details of construction of the equipment of cutting for trimming strips and the respective method can broadly be varied with respect to what has been described and illustrated, by way of non-limitative example, without by this departing from the ambit of the present invention.

1-10. (canceled)

11. A transversal cutting equipment for trimming strips of webs moving along a given direction, comprising: a stationary fixed trimming blade, a trimming blade carrying cylinder, of support for a movable trimming blade, rotatably mounted around a rotating axis, a vacuum source, and a strip collector, wherein said cutting equipment operates in association with a separating transversal cutting device for executing transversal cuts on said webs defining basic sheets with respective transversal separation edges, wherein the movable trimming blade is provided for cooperating with the fixed trimming blade for separating transversal strips of the webs adjacent to the transversal separation edges, the trimming blade carrying cylinder includes a retaining sector adjacent to the movable trimming blade, and wherein said retaining sector defines a plurality of suction openings connected to the vacuum source for retaining the strips by suction and dragging the strips up to the strip collector, said equipment is used for cutting and separating transversal strips of two webs overlapped in adherence jointly to the cutting of overlapped basic sheets, and wherein said equipment further comprises a holing mechanism for effecting holes transversely on the webs and an electronic control unit for the trimming blade carrying cylinder and the holing mechanism, wherein
the two webs overlapped in adherence include a first web and a second web of which the first web is arranged, in use, in front of the trimming blade carrying cylinder and the second web is arranged in front of the fixed trimming blade;
the holing mechanism is actuatable by the electronic control unit for carrying out a row of holes transversely to the first web, adjacent to each of the transversal separation edges;
said row of holes on the first web can be positioned in front of the suction openings of the retaining sector in association with the cutting of the strips for a suction action on the second web; and wherein
the suction action is such as to retain overlapped and in adherence on the retaining sector the strips of the first web and the strips of the second web in adherence on the strip of the first web during the cutting and the dragging of the strips up to the strip collector.

12. The cutting equipment according to claim 11, wherein the trimming blade carrying cylinder defines a longitudinal groove on the retaining sector, the suction openings are arranged along said groove and wherein, in operative conditions, the row of holes is substantially aligned with said groove.

13. The cutting equipment according to claim 12, wherein said groove has a width of 2-4 mm and a depth of 0.1-0.8 mm.

14. The cutting equipment according to claim 12, wherein the first web defines an adherence surface faced to the second web, the holing mechanism comprises a perforating device operating with perforating elements acting on the adherence surface of the first web for effecting said row of holes as transversal perforations and wherein bends and burrs resulting by the said transversal perforations are directed, in use, toward the groove of the retaining sector.

15. The cutting equipment according to claim 14, wherein the perforating device includes a tooth carrier and a contrast roller, said tooth carrier and said contrast roller are rotatable mounted on respective parallel rotation axes transversely to the given direction and define a passage space for the first web, wherein said tooth carrier mounts a transversal row of perforating teeth, and wherein said tooth carrier is servo-controlled for executing, on the fly, the transversal perforations of the first web at predetermined distances from the separation edges along said given direction.

16. The cutting equipment according to claim 15, wherein the perforation teeth are made from a blade of 1.0-2.5 mm of thickness with a pitch of about 3-5 mm and a width of the teeth at the base of 2.0-3.5 mm, for perforations of quadrangular shape of 0.8 to 1.5 mm and pitch of 3-5 mm.

17. The cutting equipment according to claim 15, wherein the contrast roller defines annular grooves for receiving the row of perforating teeth.

18. The cutting equipment according to claim 11, wherein the holing mechanism comprises a perforating device for micro-perforations comprising a support for a series of teeth distributed in rows and columns and a contrast roller for said teeth and wherein said support for the teeth is servo-controlled by the electronic unit for executing, on the fly, transversal micro-perforations on the first web, while the contrast roller has a peripheral speed synchronous with said first web.

19. The cutting equipment according to claim 18, wherein the teeth for the micro-perforations are formed of 4-5 juxtaposed blades of 0.3 mm of thickness, alternated with blades without teeth of the same thickness, in groups of 4-6 teeth, and pitch of about 15 mm, for micro-perforations of about 0.2×0.6 mm, in areas of about 2.5×6.0 mm and a pitch of 15 mm.

20. The cutting equipment according to claim 11, wherein the holing mechanism comprises a punching device with a punch holder support for a row of punches and a die support roller for respective dies and wherein the punch holder support and the die support roller are servo-controlled by the electronic unit for executing, on the fly, transversal punches on the first web.

21. The cutting equipment according to claim 20, wherein the punches are cylindrical and have a cutting diameter of 1.5-3.0 mm, with pitch of 10-20 mm, for punches of the same cutting diameter and the same pitch.

22. The cutting equipment according to claim 11, wherein said equipment is associated with a longitudinal cutting and overlapping group which obtains the two webs as a result of longitudinal cut of a continuous form and deviation of the continuous form along a first path and a second path, wherein the first path and the second path are overlapped and offset in height and wherein the holing mechanism operates along the first path or, alternatively, along the second path.

23. The cutting equipment according to claim 22, further comprising a height deflection mechanism and a compensation mechanism, wherein the height deflection mechanism is provided for positioning the two webs in an overlapped and adherence condition and the compensation mechanism is operative on a longest web portion of the two webs for compensating the difference in length between the first path and the second path before the overlapped and adherence condition.

24. The cutting equipment according to claim 11, wherein said equipment is associated with a longitudinal cutting and overlapping unit, said longitudinal cutting and overlapping unit forms the first web and the second web as a result of longitudinal cutting from a continuous form in a side by side condition and a following deviation to an overlapped and adherence condition of the first web with the second web and wherein said holing mechanism operates on the first web in the side by side condition.

25. The cutting equipment according to claim 11, further comprising a second holing mechanism for performing a second row of transversal-perforations on the first web, wherein the second row of holes is adjacent to the first row of holes and can be positioned in front of corresponding suction openings on the retaining sector of the trimming blade cylinder for an extended suction action on the second web.

26. The cutting equipment according to claim 11, wherein it provides a double actuation of the holing mechanism for performing a second row of transversal-perforations on the first web, and wherein the second row of holes is adjacent to the first row of holes and can be positioned in front of corresponding suction openings on the retaining sector of the trimming blade cylinder for an extended suction action on the second web.

27. The cutting equipment according to claim 11, wherein said separating transversal cutting device includes a stationary fixed edge blade and an edge blade-carrying cylinder with a movable edge blade arranged upstream of the stationary fixed trimming blade and the trimming blade carrying cylinder with respect to the given direction of movement of the webs for separating the overlapped basic sheets, wherein said holing mechanism is positioned upstream of the stationary fixed edge blade and the edge blade-carrying cylinder, and wherein the overlapped webs follow a cutting path passing between the fixed edge blade and the edge blade cylinder and between the fixed trimming blade and the trimming blade carrying cylinder.

28. A method of transversal cutting for trimming strips of webs moving along a given direction using an equipment comprising: a fixed trimming blade, a trimming blade-carrying cylinder rotating around a rotating axis, of support for a movable trimming blade, a vacuum source, and a strip collector, and wherein said equipment is associated with a separating transversal cutting device for executing transversal separation edges on said webs, the movable trimming blade is provided for cooperating with the fixed trimming blade for separating adjacent strips adjacent to the transversal separation edges, the trimming blade-carrying cylinder includes a retaining sector, adjacent to the movable trimming blade and wherein the retaining sector has a plurality of suction openings connected to the vacuum source for retaining the strips by suction, and dragging said strips up to the strip collector, and wherein said equipment further comprises a holing mechanism for effecting holes transversely on one of the webs, said method applies to the cutting and separation of trimming strips of two webs overlapped in adherence and comprises the following steps:
a) holing a first web, disposed in front of the trimming blade carrier cylinder, with a row of holes adjacent to a respective edge of the separation edges;
b) positioning the row of holes in front of the openings in association with the cuts for a suction action also on the second web; and
c) executing a suction action such to retain overlapped and in adherence, on the retaining sector, the strips of the first web and the strips of the second web on the second web through said holes during cutting and dragging up to the strip collector.

29. A method of transversal cutting for trimming strips according to claim 28 wherein the step a) provides the holing of two rows of holes for an extended suction action on the strips.

30. A method of transversal cutting for trimming strips according to claim 28 wherein it is used with a longitudinal cutting and overlapping group which obtains the two webs as a result of longitudinal cut of a continuous form and deviation of the continuous form along a first path and a second path, wherein the first path and the second path are overlapped and offset in height and wherein the holing mechanism operates along the first path or, alternatively, along the second path.
